(19) United States
(12) Patent Application Publication
(10) Pub. No.: US 2025/0363188 A1
(43) Pub. Date: Nov. 27, 2025

(54) NON-TRANSITORY COMPUTER-READABLE MEDIUM, LEARNING METHOD, AND INFORMATION PROCESSING APPARATUS

(71) Applicant: Fujitsu Limited, Kawasaki-shi (JP)

(72) Inventors: Yuichi ISHIDA, Kawasaki (JP); Yuma ICHIKAWA, Kawasaki (JP); Aki DOTE, Kawasaki (JP)

(73) Assignee: Fujitsu Limited, Kawasaki-shi (JP)

(21) Appl. No.: 19/194,090

(22) Filed: Apr. 30, 2025

(30) Foreign Application Priority Data
May 22, 2024 (JP) 2024-083455

(51) Int. Cl. G06F 17/18

(52) U.S. Cl. CPC G06F 17/18

(57) ABSTRACT

Provided is a non-transitory computer-readable medium having stored therein a learning program for causing a computer to execute a process. The process includes a first process of generating a probability distribution model by learning a probability distribution having fewer peaks than an objective probability distribution, and a second process of generating a new probability distribution model by learning a probability distribution closer to the objective probability distribution than a learned probability distribution using a parameter of a generated probability distribution model.

### CROSS-REFERENCE TO RELATED APPLICATION

This application is based upon and claims the benefit of priority of Japanese Patent Application No. 2024-083455 filed on May 22, 2024, the entire contents of which are incorporated herein by reference.

### FIELD

A certain aspect of the present embodiments relates to a non-transitory computer-readable medium, a learning method, and an information processing apparatus.

### BACKGROUND

Techniques for learning a model are disclosed (see, for example, Patent Document 1: Japanese Laid-Open Patent Publication No. 2019-95600, Patent Document 2: Japanese Laid-Open Patent Publication No. 2023-129309, Patent Document 3: U.S. Laid-Open Patent Publication No. 2022/8368373, and Patent Document 4: U.S. Laid-Open Patent Publication No. 2019/0347570).

### SUMMARY

According to an aspect of the present disclosure, there is provided a non-transitory computer-readable medium having stored therein a learning program for causing a computer to execute a process, the process including: a first process of generating a probability distribution model by learning a probability distribution having fewer peaks than an objective probability distribution; and a second process of generating a new probability distribution model by learning a probability distribution closer to the objective probability distribution than a learned probability distribution using a parameter of a generated probability distribution model.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1A is a diagram illustrating a simple probability distribution.

FIG. 1B is a diagram illustrating a complex probability distribution.

FIG. 2A is a functional block diagram illustrating an overall configuration of an information processing apparatus.

FIG. 2B is a hardware configuration diagram of the information processing apparatus.

FIG. 3 is a flowchart illustrating an example of the operation of the information processing apparatus.

FIG. 4 is a diagram illustrating a learning result.

### DETAILED DESCRIPTION

However, even if a complex probability distribution is modeled by machine learning, it is difficult to generate a model with high accuracy.

In one aspect, an object of the present disclosure is to provide a non-transitory computer-readable medium, a learning method, and an information processing apparatus capable of learning a complex probability distribution.

In the field of machine learning, techniques (generative models) for modeling unknown complex probability distributions by machine learning have been developed. In particular, a generative model Q_{θ}(x) characterized by a parameter θ has been developed as a mainstream. For example, RBM: Restricted Boltzmann Machine, VAE: Variational Autoencoder, GAN: Generative Adversarial Network, and the like are cited as the generation model Q_{θ}(x).

In the field of statistics, techniques have been proposed for sampling from a probability distribution under a situation where a functional form other than a normalization constant of the probability distribution is given. For example, techniques have been proposed for sampling from the probability distribution in Bayesian statistical modeling. Specifically, it is assumed that a functional form other than the normalization constant is given as illustrated in the following equation (1). In the following equation (1), Z is a normalization constant, making it difficult to evaluate the value of Z.

$$( x ) = \frac{1}{Z} ( x ) , Z = \int dx ( x ) \qquad ( 1 )$$

Recently, a framework has been proposed that applies machine learning techniques to speed up sampling under a situation where a functional form P other than the normalization constant of the probability distribution is given. Specific examples will be described below.

First, learning in the case where learning data is prepared in advance (learning with data) will be described. In the learning with data, an appropriate loss function is defined for a generation model Q_{θ}(x) by using the learning data D of the following equation (2) prepared in advance and the function of the following equation (3) as a teacher, and the parameter θ is determined so that the loss function becomes small.

$$𝒟 = {\{ {x}_{μ} \}}_{μ = 1}^{P} \qquad ( 2 )$$

$$( 3 )$$

For example, in Huang, L. and Wang, “Accelerated monte carlo simulations with restricted boltzmann machines” Physical Review B, 95(3): 035105, the parameter is updated by optimizing the following equation (4) using the learning data.

$${𝔼}_{𝒟} {‖ log ( x ) - log {θ}_{} ( x ) ‖}^{2} \qquad ( 4 )$$

When the function of the above equation (3) is not obtained in the learning with data, the parameter is determined by maximizing a logarithmic likelihood of the following equation (5) using only the learning data D.

$${𝔼}_{𝒟} [ log {θ}_{} ( x ) ] \qquad ( 5 )$$

Next, learning in the case where no learning data is prepared in advance (learning without data) will be described. In this case, a sample sequence (self-sample) of the following equation (6) is generated from the generation model Q_{θ}(x), an appropriate loss is defined from the self-sample and the function of the following equation (7), and the parameter 0 is determined so that the loss function becomes small.

$$\hat{𝒟} = {\{ {\hat{x}}_{μ} \}}_{μ = 1}^{\hat{P}} \qquad ( 6 )$$

$$( x ) \qquad ( 7 )$$

For example, in Albergo, M. S., Kanwar, G., and Shanahan, P. E. (2019), “Flow-based generative models for markov chain monte carlo in lattice field theory”, Physical Review D, 100 (3): 034515, the parameter is determined to minimize a KL Divergence of the following equation (8) by using the self-sample of the above equation (6).

$${𝔼}_{\hat{𝒟}} [ log {θ}_{} ( x ) - log ( x ) ] \qquad ( 8 )$$

The probability distribution to be modeled will be described, and advantages and disadvantages of the learning with data and the learning without data will be summarized.

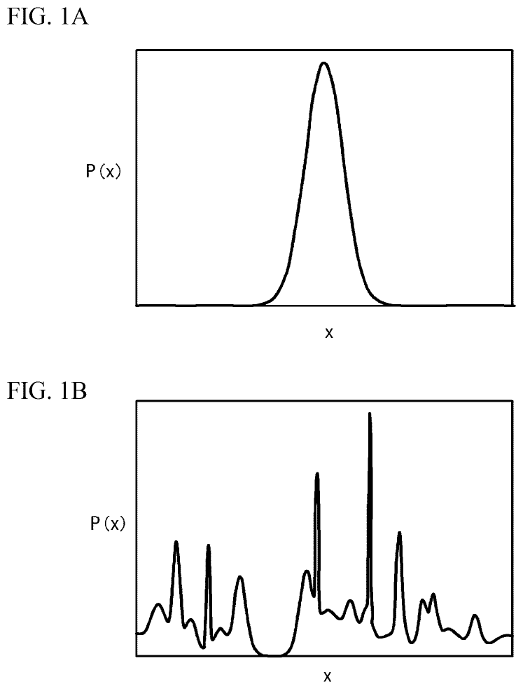

First, an image of a probability distribution to be learned will be described. The probability distribution includes a simple probability distribution having a simple distribution and a complex probability distribution having a complex distribution. FIG. 1A is a diagram illustrating a simple probability distribution. FIG. 1B is a diagram illustrating a complex probability distribution. As illustrated in FIG. 1B, the complex probability distribution is a multi-peaked probability distribution having a plurality of peaks. As illustrated in FIG. 1A, the simple probability distribution is a probability distribution having fewer peaks than the complex probability distribution. As an example, the simple probability distribution is a probability distribution that has only one peak.

In FIGS. 1A and 1B, the description is made in two dimensions for the sake of simplicity of description, but even in a three or more dimensional space, the complex probability distribution is the multi-peaked probability distribution having the plurality of peaks, and the simple probability distribution is the probability distribution having fewer peaks than the complex probability distribution.

In the learning with data, even in the complex probability distribution illustrated in FIG. 1B, if the learning data for learning a region of each peak is prepared, the advantage is that the multi-peaked distribution can be learned. On the other hand, the disadvantage is that learning data is required in advance. Another disadvantage is that the above equation (7) cannot be used well and it is difficult to output an appropriate value as the parameter θ.

Next, the learning without data has an advantage that it is not necessary to prepare the learning data in advance. On the other hand, since there is no learning data for learning the region of each peak, the learning without data has a disadvantage that it is difficult to learn anything other than the simple probability distribution as illustrated in FIG. 1A. When learning is performed on the multi-peaked distribution as illustrated in FIG. 1B by the learning without data, it is typically difficult to learn anything other than only one peak.

From the above, it is difficult to learn the complex probability distribution (for example, a multi-peaked distribution having a large number of clusters and a plurality of peaks) in both of the learning with data and the learning without data.

Therefore, in the following embodiment, an example in which a complex probability distribution can be learned will be described.

### First Embodiment

First, the principle of the present embodiment will be described.

It is assumed that a functional form P(x) of an objective probability distribution or a functional form obtained by removing the normalization constant from the functional form P(x) is obtained. Since the obtained functional form does not have a significant effect, even when the functional form excluding the normalization constant is obtained, it is described as P(x) without distinction.

In the present embodiment, the probability distribution simpler than the objective probability distribution to be modeled is learned in advance, and the objective probability distribution is learned using the parameter of the obtained model as an initial value. However, since it is generally difficult to prepare a sufficiently simple distribution close to the objective probability distribution, this method is multi-staged so that learning is performed sequentially starting with the distribution that is easy to learn.

Specifically, a parameter λ representing the complexity of the probability distribution is first introduced to expand the objective probability distribution P(x) to a parametrized probability distribution P(x; γ) satisfying the following conditions:
0<γ≤1 and P(x; γ) matches the objective probability distribution for γ=1.
P(x; γ′) is closer to the objective probability distribution than P(x; γ) for γ<γ′.

Here, “closer to the objective probability distribution” means that the Wasserstein metric is small.

Next, a monotonous increasing sequence γ₀<γ₁< . . . <γ_{K}=1 is prepared, where γ_{K}=1. In learning for P(x; γ₀), a random value is set as an initial value of the parameter. When learning is performed with the probability distribution P(x; γ_{K}) as an objective, the learning parameter of the model learned with the objective of P(x; γ_{K-1}) is used as the initial value.

By employing such a technique, the learning of a simpler probability distribution is started. This increases the accuracy of the machine learning even with the learning without data. Even if the probability distribution to be learned approaches the objective probability distribution and becomes complicated as a result, the accuracy of the machine learning is also improved since the parameter obtained by learning the simpler probability distribution can be used. From the above, according to the present embodiment, even if the objective probability distribution is the complex probability distribution, it is possible to perform learning with high accuracy.

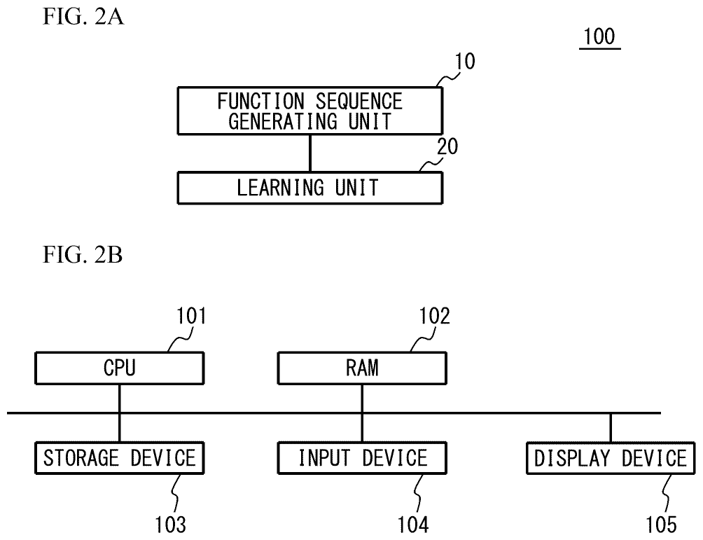

Next, the structure of the apparatus for realizing the above-described principle of solution will be described. FIG. 2A is a functional block diagram illustrating the overall configuration of an information processing apparatus 100 according to the present embodiment. The information processing apparatus 100 is a server for optimization processing, or the other devices. As illustrated in FIG. 2A, the information processing apparatus 100 functions as a function sequence generating unit 10, a learning unit 20, and the like.

FIG. 2B is a hardware configuration diagram of the information processing apparatus 100. As illustrated in FIG. 2B, the information processing apparatus 100 includes a CPU 101, a RAM 102, a storage device 103, an input device 104, a display device 105, and the like.

The CPU (Central Processing Unit) 101 is a central processing unit. The CPU 101 includes one or more cores. The RAM (Random Access Memory) 102 is a volatile memory that temporarily stores programs executed by the CPU 101, data processed by the CPU 101, and the like. The storage device 103 is a nonvolatile storage device. As the storage device 103, for example, a ROM (Read Only Memory), a solid state drive (SSD) such as a flash memory, a hard disk driven by a hard disk drive, or the like can be used. The storage device 103 stores a learning program. The input device 104 is a device for a user to input necessary information, and is a keyboard, a mouse, or the like. The display device 105 is a display device for displaying the learning result of the learning unit 20 on a screen. The CPU 101 executes the learning program, thereby implementing each unit of the information processing apparatus 100. Note that hardware such as a dedicated circuit may be used as each unit of the information processing apparatus 100.

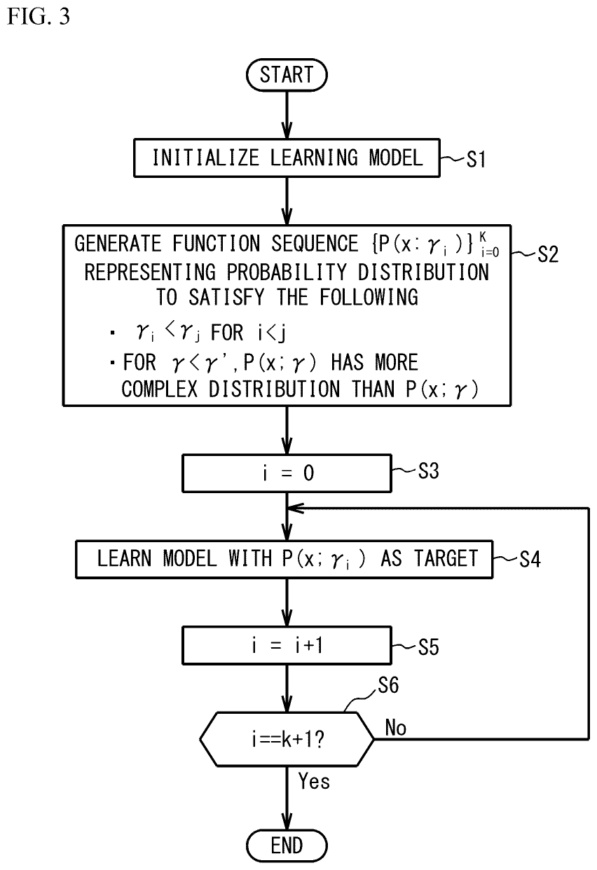

FIG. 3 is a flowchart illustrating an example of the operation of the information processing apparatus 100. As illustrated in FIG. 3, the learning unit 20 initializes a learning model (step S1).

Next, the function sequence generating unit 10 generates a function sequence representing a probability distribution and represented by the following equation (9) so as to satisfy the following (step S2).
γᵢ<γⱼ for i<j.
For γ<γ′, P(x; γ′) is closer to the objective probability distribution than P(x; γ). Note that i takes a value of either 0 or an integer up to K. When 0<γ≤1 and γ=1, P(x; γ) matches the objective probability distribution.

$${\{ P ( x ; {γ}_{i} ) \}}_{i = 0}^{K} \qquad ( 9 )$$

Next, the learning unit 20 sets i=0 (step S3). This initializes the value of i.

Next, the learning unit 20 learns a model with P(x; γi) as a target (step S4).

Next, the learning unit 20 increases the value of i by 1 by setting i as i=i+1 (step S5).

Next, the learning unit 20 determines whether the value of i is k+1 by determining whether i==k+1 is satisfied (step S6). This makes it possible to determine whether the learning of the model has been completed for all γ values from γ₀ to γ_{K}.

If the determination result in step S6 is determined as “No”, the process is executed again from step S4. If the determination result in step S6 is determined as “Yes”, the execution of the flowchart ends. The display device 105 displays the learning result.

Next, a more specific example will be described. As the probability distribution P (x; γ), an extended distribution as illustrated in the following equation (10) can be used.

$$( x ; γ ) ≡ , Z ( γ ) = \int dx {γ}^{} ( x ) \qquad ( 10 )$$

Next, consider a situation where a sample sequence with parameters γ₀<γ₁< . . . <γ_{K}=1 is given. First, learning is performed on data according to P(x; γ₀), and then learning is performed on data according to P(x; γ₁) using the obtained learning parameter as an initial value. Thereafter, similarly, learning is performed on data according to P(x; γₖ) using a learning parameter obtained by performing learning on data according to P(x; γₖ₋₁) as an initial value.

Next, another example will be described. A probability distribution S that is easy to sample is introduced into the probability distribution P(x; γ), and an extended distribution as illustrated in the following equation (11) is considered.

$$( x ; γ ) ≡ , Z ( γ ) = \int dx {}^{γ} ( x ) {S}^{1 - γ} ( x ) \qquad ( 11 )$$

Next, consider a situation where a sample sequence with parameters γ₀<γ₁< . . . <γ_{K}=1 is given. In addition, “S” in the above equation (11) is a uniform distribution, a Bernoulli distribution, a normal distribution, or the like. First, learning is performed on data according to P(x; γ₀), and then learning is performed on data according to P(x; γ₁) using the obtained learning parameter as an initial value. Thereafter, similarly, learning is performed on data according to P(x; γₖ) using a learning parameter obtained by performing learning on data according to P(x; γₖ₋₁) as an initial value.

The following describes the verification of the effect of the present embodiment.

PT: Parallel Tempering is performed on Gset G1 which is a benchmark problem of MCP: Max Cut Problem, thereby preparing the learning data. In PT, a MCMC (Markov Chain Monte Carlo) method is operated using the Boltzmann distribution at different temperatures, and the state is exchanged between different temperatures at a constant frequency. This allows efficient sampling at a lower temperature than in the conventional MCMC method.

Then, a restricted Boltzmann machine (RBM) is trained with the learning with data. A loss function MSE(θ) in this case is a mean square error between the energy of the RBM and the energy of the MCP, as illustrated in the following equation (12). In addition, θ is a learning parameter, β is an inverse temperature, D is learning data, F_{θ}(x) is the energy of the RBM, and E(x) is the energy of the MCP.

$$M S E ( θ ) = \frac{1}{\vert 𝒟 \vert} {\sum }_{x ∈ 𝒟} {( {F}_{θ} ( x ) - β E ( x ) )}^{2} \qquad ( 12 )$$

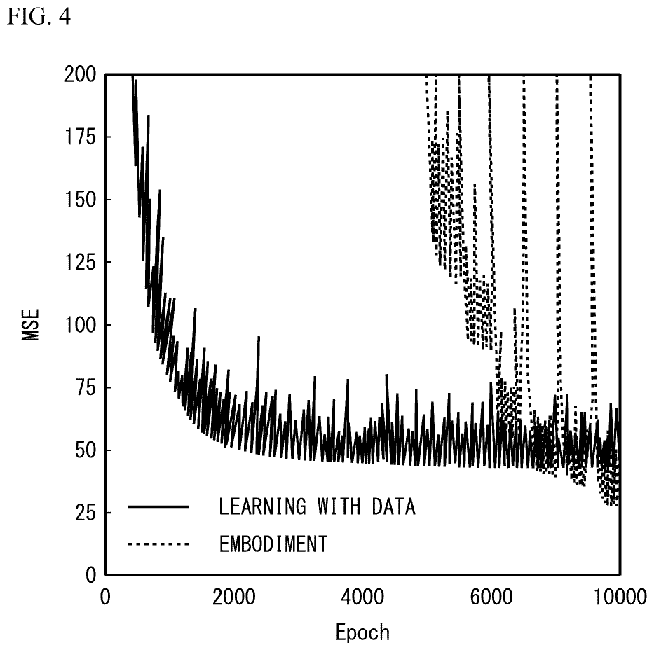

FIG. 4 is a diagram illustrating a learning result. In FIG. 4, the horizontal axis represents the number of epochs, and the vertical axis represents an MSE. In FIG. 4, the result of general learning with data is also illustrated. In the learning with data, 8000 epochs were learned using only the learning data obtained at the lowest temperature. In the above PT, since the Boltzmann distribution generally becomes more complicated as the temperature decreases, by executing the PT so that the objective probability distribution becomes a minimum temperature, it is possible to prepare simple to complex distributions to approach the objective distribution, and to acquire the learning data at each temperature. In the method according to the present embodiment, the learning was performed while the value of y is made close to 1 for 500 epochs in order from a maximum temperature. Specifically, a total of 16 temperatures were prepared, and the minimum temperature was set to 0.5 and the maximum temperature was set to 4.0. An intermediate temperature was determined by the following equation (13) with N=16.

$${T}_{i} = {T}_{1} exp ( \frac{i - 1}{N - 1} log \frac{{T}_{N}}{{T}_{1}} ) for i = 1 , … , N \qquad ( 13 )$$

As illustrated in FIG. 4, the MSE is 49.4 in the general learning with data, whereas it is 37.4 in the method according to the present embodiment. From this result, it is understood that the performance is improved in the method according to the present embodiment.

In the above embodiment, the learning at γ₀ corresponds to a first process of generating a probability distribution model by learning a probability distribution having a distribution simpler than an objective probability distribution. The learning at γ₁ . . . . γ_{K} corresponds to a second process of generating a new probability distribution model by learning a probability distribution closer to the objective probability distribution than a learned probability distribution using a parameter of a generated probability distribution model. The learning unit 20 corresponds to a learning unit which executes a first process for generating a probability distribution model by learning a probability distribution having a distribution simpler than an objective probability distribution, and a second process for generating a new probability distribution model by learning a probability distribution closer to the objective probability distribution than a learned probability distribution by using a parameter of a generated probability distribution model.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. A non-transitory computer-readable medium having stored therein a learning program for causing a computer to execute a process, the process comprising:
a first process of generating a probability distribution model by learning a probability distribution having fewer peaks than an objective probability distribution; and
a second process of generating a new probability distribution model by learning a probability distribution closer to the objective probability distribution than a learned probability distribution using a parameter of a generated probability distribution model.

2. The non-transitory computer-readable medium according to claim 1, wherein
a distribution satisfying 0<γ≤1, P(x; γ)≡P^{γ}(x)/Z(γ), and Z(γ)=∫dxP^{γ}(x) is prepared for P(x) representing the objective probability distribution, and
a value of γ in the second process is made larger than a value of γ in the first process.

3. The non-transitory computer-readable medium according to claim 1, wherein
the computer is caused to repeatedly execute the second process two or more times.

4. The non-transitory computer-readable medium according to claim 3, wherein
a distribution satisfying 0<γ≤1, P(x; γ)≡P^{γ}(x)/Z(γ), and Z(γ)=∫dxP^{γ}(x) is prepared for P(x) representing the objective probability distribution,
a value of γ in the second process is made larger than a value of γ in the first process, and
the value of γ is made larger when the second process is repeated.

5. The non-transitory computer-readable medium according to claim 1, wherein
a distribution of 0<γ≤1, P(x; γ)≡P^{γ}(x)S^{1-γ}(x)/Z(γ), Z(γ)=∫dx P^{γ}(x)S^{1-γ}(x) is prepared for P(x) representing the objective probability distribution, and
a value of γ in the second process is made larger than a value of γ in the first process.

6. The non-transitory computer-readable medium according to claim 1, wherein
the computer is caused to repeatedly execute the second process two or more times,
a distribution of 0<γ≤1, P(x; γ)≡P^{γ}(x)/Z(γ), Z(γ)=∫dxP^{γ}(x)S^{1-γ}(x) is prepared for P(x) representing the objective probability distribution,
a value of γ in the second process is made larger than a value of γ in the first process, and
the value of γ is made larger when the second process is repeated.

7. A learning method causing a computer to execute a process, the process comprising:
a first process of generating a probability distribution model by learning a probability distribution having fewer peaks than a objective probability distribution; and
a second process of generating a new probability distribution model by learning a probability distribution closer to the objective probability distribution than a learned probability distribution using a parameter of a generated probability distribution model.

8. The learning method according to claim 7, wherein
a distribution satisfying 0<γ≤1, P(x; γ)≡P^{γ}(x)/Z(γ), and Z(γ)=∫dxP^{γ}(x) is prepared for P(x) representing the objective probability distribution, and
a value of γ in the second process is made larger than a value of γ in the first process.

9. The learning method according to claim 7, wherein
the computer is caused to repeatedly execute the second process two or more times.

10. The learning method according to claim 9, wherein
a distribution satisfying 0<γ≤1, P(x; γ)≡P^{γ}(x)/Z(γ), and Z(γ)=∫dxP^{γ}(x) is prepared for P(x) representing the objective probability distribution,
a value of γ in the second process is made larger than a value of γ in the first process, and
the value of γ is made larger when the second process is repeated.

11. The learning method according to claim 7, wherein
a distribution of 0<γ≤1, P(x; γ)≡P^{γ}(x) S^{1-γ}(x)/Z(γ), Z(γ)=∫dxP^{γ}(x)S^{1-γ}(x) is prepared for P(x) representing the objective probability distribution, and
a value of γ in the second process is made larger than a value of γ in the first process.

12. The learning method according to claim 7, wherein
the computer is caused to repeatedly execute the second process two or more times,
a distribution of 0<γ≤1, P(x; γ)≡P^{γ}(x)/Z(γ), Z(γ)=∫dxP^{γ}(x)S^{1-γ}(x) is prepared for P(x) representing the objective probability distribution,
a value of γ in the second process is made larger than a value of γ in the first process, and
the value of γ is made larger when the second process is repeated.

13. An information processing apparatus comprising:
a memory;
a processor coupled to the memory and the processor configured to:
generate, as a first process, a probability distribution model by learning a probability distribution having fewer peaks than a objective probability distribution; and
generate, as a second process, a new probability distribution model by learning a probability distribution closer to the objective probability distribution than a learned probability distribution using a parameter of a generated probability distribution model.

14. The information processing apparatus according to claim 13, wherein
the processor prepares a distribution satisfying 0<γ≤1, P(x; γ)≡P^{γ}(x)/Z(γ), and Z(γ)=∫dxP^{γ}(x) for P(x) representing the objective probability distribution, and makes a value of γ in the second process larger than a value of γ in the first process.

15. The information processing apparatus according to claim 13, wherein
the processor repeatedly executes the second process two or more times.

16. The information processing apparatus according to claim 15, wherein
the processor prepares a distribution satisfying 0<γ≤1, P(x; γ)≡P^{γ}(x)/Z(γ), and Z(γ)=∫dxP^{γ}(x) for P(x) representing the objective probability distribution, makes a value of γ in the second process larger than a value of γ in the first process, and makes the value of γ larger when the second process is repeated.

17. The information processing apparatus according to claim 13, wherein
the processor prepares a distribution of 0<γ≤1, P(x; γ)≡P^{γ}(x) S^{1-γ}(x)/Z(γ), Z(γ)=∫dxP^{γ}(x)S^{1-γ}(x) for P(x) representing the objective probability distribution, and makes a value of γ in the second process larger than a value of γ in the first process.

18. The information processing apparatus according to claim 13, wherein
the processor repeatedly executes the second process two or more times, prepares a distribution of 0<γ≤1, P(x; γ)≡P^{γ}(x)/Z(γ), Z(γ)=∫dxP^{γ}(x)S^{1-γ}(x) for P(x) representing the objective probability distribution, makes a value of γ in the second process larger than a value of γ in the first process, and makes the value of γ larger when the second process is repeated.
